(19) United States
(12) Patent Application Publication
(10) Pub. No.: US 2004/0050944 A1
(43) Pub. Date: Mar. 18, 2004

(54) Vehicle air conditioner

(76) Inventors: Ken Matsunaga, Kariya-city (JP); Hisashi Ieda, Nagoya-city (JP)

Correspondence Address: HARNESS, DICKEY & PIERCE, P.L.C., P.O. BOX 828, BLOOMFIELD HILLS, MI, 48303, US

(21) Appl. No.: 10/660,269

(22) Filed: Sep. 11, 2003

(30) Foreign Application Priority Data
Sep. 12, 2002 (JP) 2002-267363

(51) Int. Cl. B60H 1/02

(52) U.S. Cl. 237/12.3 B

(57) ABSTRACT

In an air conditioner for a vehicle having a temperature-controlled apparatus such as a fuel cell system, a heater core heats air by using unnecessary thermal energy from the fuel cell system. Further, a switching valve is controlled to switch between a first circuit and a second circuit. Cooling water is circulated between the heater core and the fuel cell system in the first circuit, and passes through the heater core while by passing the fuel cell system in the second circuit. When a cooling water temperature flowing from the heater core is lower than a cooling water temperature from the fuel cell system, the switching valve is controlled by a control unit to select the first circuit. Accordingly, the heater core can effectively use the unnecessary thermal energy from the fuel cell system.

### CROSS-REFERENCE TO RELATED APPLICATION

This application is related to and claims priority from Japanese Patent Application No. 2002-267363 filed on Sep. 12, 2002, the content of which is hereby incorporated by reference.

### BACKGROUND OF THE INVENTION

1. Field of the Invention

The present invention relates to a vehicle air conditioner having a heating heat exchanger for heating air to be blown into a passenger compartment by using hot water (cooling water) heated by a temperature-controlled apparatus such as a fuel cell system.

2. Description of Related Art

In a vehicle air conditioner disclosed in JP-A-2001-315524, for example, a passenger compartment is heated by using cooling water of a fuel cell system (F/C) as a heat source. The fuel cell system is thermal-controlled to increase its operation efficiency. The vehicle air conditioner includes a heater core, a first cooling-water circuit, a second cooling-water circuit, a switching valve and an auxiliary heater. The heater core mainly heats air to be blown into the passenger compartment, and the auxiliary heater assists the heating operation of the heater core. In the first cooling-water circuit, cooling water of the fuel cell system circulates the fuel cell system and the heater core. In the second cooling-water circuit, the cooling water does not passes through the fuel cell system, but passes through the heater core. The switching valve is provided to switch one of the first and second cooling-water circuits.

When the fuel cell system is stably operated in capable of releasing its thermal energy, the first cooling-water circuit is selected by the switching valve, so that cooling water flows from the fuel cell system into the heater core. In this case, the heater core can heat the blown air. When the blown air cannot be heated to a desired temperature only by using the thermal energy released from the fuel cell system, the auxiliary heater is operated to assist the heating operation of the heater core. On the other hand, when the fuel cell system is unstably operated in incapable of releasing its thermal energy, the second cooling-water circuit is selected by the switching valve, and the auxiliary heater is operated to heat the blown air to the desired temperature.

However, in the above vehicle air conditioner, even when the fuel cell system can release its thermal energy, and even when the blown air is required to be heated by the heater core, the thermal energy, which is unnecessary in the fuel cell system, cannot be used in the heater core in some temperature conditions of the cooling water.

### SUMMARY OF THE INVENTION

Therefore, it is an object of the present invention to provide a vehicle air conditioner having a heating heat exchanger capable of effectively using an unnecessary thermal energy of a temperature-controlled apparatus.

According to the present invention, in an air conditioner for a vehicle having a temperature-controlled apparatus, a heating heat exchanger is provided for heating air to be blown into a passenger compartment of the vehicle by using cooling water for cooling the temperature-controlled apparatus as a heating source, the cooling water passes through the temperature-controlled apparatus and the heating heat exchanger through a first circuit, the cooling water passes through the heating heat exchanger while bypassing the temperature-controlled apparatus through a second circuit, a switching device is provided for switching a cooling water circuit between the first and second circuits, and a control unit controls the switching device so as to select the first circuit when a cooling water temperature flowing out of the heating heat exchanger is lower than a cooling water temperature flowing out of the temperature-controlled apparatus. Accordingly, the cooling water, flowing out of the heating heat exchanger, is heated by the temperature-controlled apparatus, and is circulated into the heating heat exchanger. Therefore, the heating heat exchanger can effectively heat air by using the unnecessary thermal energy from the temperature-controlled apparatus.

The air conditioner can be provided with an auxiliary heater for heating air to be blown into the passenger compartment by supplying thermal energy to the cooling water to be circulated into the heating heat exchanger. For example, the auxiliary heater is arranged in the first and second circuits to heat the cooling water to be circulated into the heating heat exchanger in the first and second circuits.

Preferably, the control unit calculates the cooling water temperature flowing out of the heating heat exchanger, based on a cooling water temperature flowing into the heating heat exchanger and a heat radiation capacity in the heating heat exchanger. In this case, the switching control of the switching device can be performed without directly detecting the cooling water temperature flowing out of the heating heat exchanger. Alternatively, the control unit calculates the cooling water temperature flowing out of the heating heat exchanger, based on a cooling water temperature flowing into the heating heat exchanger, a flow amount of the cooling water passing through the heating heat exchanger, an air temperature flowing into the heating heat exchanger and an air flow amount passing through the heating heat exchanger. Further, the control unit can control the switching device so as to select one of the first and second circuits based on the cooling water temperature detected by a temperature sensor.

More preferably, the first circuit is selected, only when air to be blown into the passenger compartment is required to be heated by the heating heat exchanger and waste heat from the temperature-controlled apparatus is permitted to be used. Therefore, it can prevent the cooling water circulates in the first circuit when it is unnecessary to heat air by using the heating heat exchanger, or when there is no thermal heat to be radiated from the temperature-controlled apparatus.

According to the present invention, when a fuel cell system is used as the temperature-controlled apparatus, the advantages of the present invention can be effectively improved.

### BRIEF DESCRIPTION OF THE DRAWINGS

Additional objects and advantages of the present invention will be more readily apparent from the following detailed description of preferred embodiments when taken together with the accompanying drawings, in which:

FIG. 1A is a schematic diagram showing a vehicle air conditioner according to a preferred embodiment of the present invention, and FIG. 1B is a block diagram showing a control system of an air-conditioning control unit of the vehicle air conditioner;

FIGS. 2A and 2B are schematic diagrams showing operation of a switching valve according to the preferred embodiment;

FIG. 3 is a flow diagram showing a part of a control process of the air-conditioning control unit according to the preferred embodiment;

FIG. 4 is a flow diagram showing an another part of the control process of the air-conditioning control unit according to the preferred embodiment;

FIG. 5 is a flow diagram showing an another part of the control process of the air-conditioning control unit according to the preferred embodiment;

FIG. 6 is a flow diagram showing a further another part of the control process of the air-conditioning control unit according to the preferred embodiment;

FIG. 7 is a graph showing a control of a blower level (i.e., air blowing amount) according to the preferred embodiment;

FIG. 8 is a graph showing a control of an operation mode according to the preferred embodiment;

FIG. 9A is a graph showing a relationship between a temperature difference (TW−TE) and a reducing temperature T1, and FIG. 9B is a schematic diagram showing a determination of a waste heat usage of a fuel cell system, according to the preferred embodiment;

FIG. 10 is a graph showing a relationship between a target air temperature TEO blown from an evaporator and an outside air temperature Tam, according to the preferred embodiment;

FIG. 11 is a graph showing a relationship between a control value Φ and an air flow amount blown from an air outlet, according to the preferred embodiment;

FIG. 12 is a schematic diagram showing a main part of a vehicle air conditioner according to an another embodiment of the present invention; and

FIG. 13 is a schematic diagram showing a determination of a waste heat usage according to an another embodiment of the present invention.

### DETAILED DESCRIPTION OF THE PRESENTLY PREFERRED EMBODIMENTS

Preferred embodiments of the present invention will be described hereinafter with reference to the appended drawings.

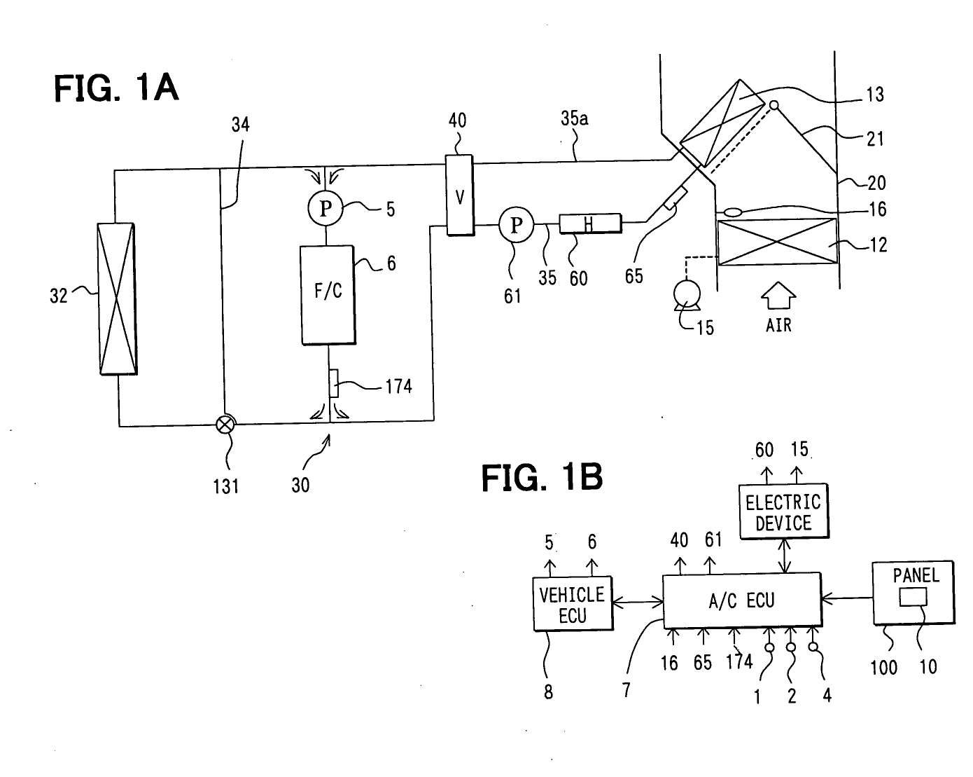

In a preferred embodiment, the present invention is typically applied to an air conditioner for a fuel cell vehicle, as shown in FIG. 1A. A fuel cell system (F/C) 6 is required to be temperature-controlled, and is connected to a cooling water circuit 30 where cooling water is circulated. The cooling water circuit 30 includes a first cooling-water passage 34 at a left side of the fuel cell system 6 in FIG. 1A and a second cooling-water passage 35 at a right side of the fuel cell system 6 in FIG. 1A. In the second cooling-water passage 35, cooling water is circulated between a heater core 13 and the fuel cell system 6. A water pump 5 is provided in the fuel cell system 6 to circulate cooling water in the cooling water circuit 30. The fuel cell system 6 is temperature-controlled with the cooling water in a temperature area (e.g., 72-80° C.) where the power generation efficiency can be effectively improved in the fuel cell system 6.

Both of upstream and downstream sides of a radiator 32 are connected to the first cooling-water passage 34, and a thermostat valve 131 is disposed between the radiator 32 and its upstream connection point with the first cooling-water passage 34. When a temperature of cooling water flowing in the first cooling-water passage 34 becomes equal to or higher than a predetermined temperature (e.g., 80° C.), the thermostat valve 131 is opened, so that cooling water flows into the radiator 32 to be radiated in the radiator 32. That is, when the temperature of cooling water flowing in the first cooling-water passage 34 becomes equal to or higher than the predetermined temperature, heat of the fuel cell system 6 is radiated from the radiator 32. Therefore, the temperature of the fuel cell system 6 is not increased to be higher than the temperature area where power generation efficiency can be effectively increased. A vehicle control unit 8 (vehicle ECU) controls the fuel cell system 6, the water pump 5, a blower fan (not shown) of the radiator 32 and the like in accordance with a vehicle running state, an environment condition and the like.

As shown in FIG. 1A, a water pump 61, an electric heater 60 as an auxiliary heater, and a water temperature sensor 65 are provided between the fuel cell system 6 and the heater core 13 in the second cooling-water passage 35. The water temperature sensor 65 detects a temperature TW of cooling water flowing into the heater core 13, and outputs detected temperature information of cooling water to an air-conditioning control unit (A/C ECU) 7, as shown in FIG. 1B. A switching valve 40 is disposed in the second cooling-water passage 35 to cross both of a downstream side of the heater core 13 and an upstream side of the water pump 61, as shown in FIG. 1A. The switching valve 40 switches a stream direction of cooling water flowing out of the heater core 13 between a direction toward the fuel cell system 6 and a direction to the water pump 61. Further, a water temperature sensor 174, for detecting a temperature TWFC of cooling water flowing out of the fuel cell system 6, is disposed in the cooling water circuit 30 downstream of the fuel cell system 6. The water temperature sensor 174 outputs detected temperature information of cooling water to the A/C control unit 7, as shown in FIG. 13.

On the other hand, an evaporator 12 is disposed in an air duct 20 so as to cross an entire area of the air duct 20, and cools air blown by a blower (not shown) disposed upstream of the evaporator 12 in the air duct 20. The heater core 13 is disposed in the air duct 20 downstream of the evaporator 12 so as to cross substantially half of the air duct 20, and heats cool air after passing through the evaporator 12. Further, an air mixing damper 21, for adjusting a temperature of air to be blown into a passenger compartment, is disposed upstream of the heater core 13. An air temperature sensor 16, for detecting a temperature TE of cool air blown immediately from the evaporator 12, is disposed in the air duct 20 between the evaporator 12 and the air mixing damper 21. The air temperature sensor 16 outputs detected temperature information of the blown air to the A/C control unit 7.

An electric compressor 15 of a refrigerant cycle compresses refrigerant to be circulated in a refrigerant cycle (not shown). Then, the refrigerant in the refrigerant cycle after being cooled and decompressed is heat-exchanged with the blown air in the evaporator 12, thereby cooling the blown air. An air-conditioning inverter (A/C inverter) 9 carries electrical current to the electric compressor 15 and the electric heater 60, based on output signals from the A/C control unit 7. The air duct 20 has a defroster air outlet, a face air outlet and a foot air outlet, at downstream positions of the heater core 13. Conditioned air having been thermal-controlled by the evaporator 12 and the heater core 13 is blown from the defroster air outlet to a windshield, is blown from the face air outlet to the upper half body of a passenger, and is blown from the foot air outlet to the foot portion of the passenger. The defroster air outlet, the face air outlet and the foot air outlet are opened and closed by a mode switching damper to set an air outlet mode. Further, an inside-outside air switching damper (not shown), for adjusting an introduction ratio between inside air and outside air, is disposed upstream of the blower.

An inside air temperature sensor 1 detects air temperature in the passenger compartment, and an outside air temperature sensor 2 detects air temperature outside the vehicle. Further, a sunlight sensor 4 detects solar radiation amount entering the passenger compartment. A temperature setting device 10, for setting a target blowing temperature TAO of air to be blown into the passenger compartment, is disposed on an operation panel 100. Signals from the sensors 1, 2, 4 and the temperature setting device 10 are input to the A/C control unit 7. The A/C control unit 7 calculates a necessary air-conditioning capacity by using predetermined program and map based on signals from the above sensors 1, 2, 4, 16, 65, 174 and the temperature setting device 10 and the like. Further, the A/C control unit 7 outputs signals for controlling the electric compressor 15, the switching valve 40, the electric heater 60, the water pump 61 and various actuators for driving dampers and the likes. The A/C control unit 7 outputs information about thermal energy and electric energy required for the air conditioner, to the vehicle control unit 8.

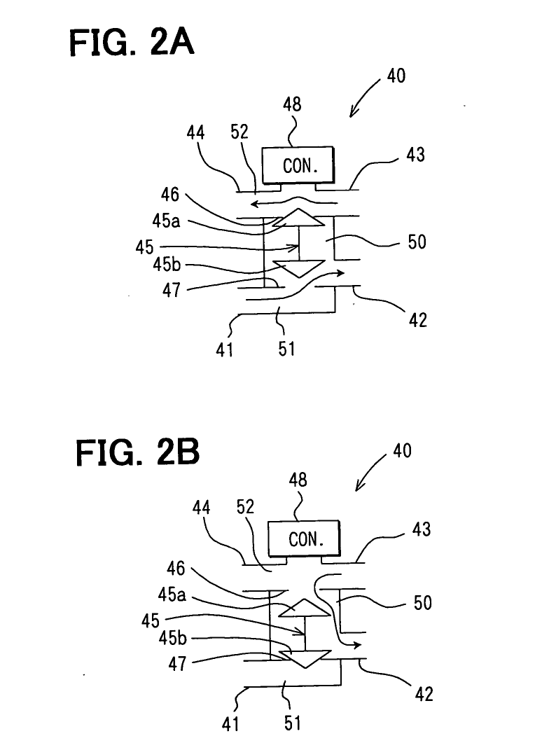

Next, the structure of the switching valve 40 will be described with reference to FIGS. 2A, 2B. The switching valve 40 has a F/C side inlet 41, a heater-core side outlet 42, a heater-core side inlet 43 and a F/C side outlet 44. Cooling water, flowing from the fuel cell system 6, flows from the F/C side inlet 41 into the switching valve 40. The cooling water, flowing into the switching valve 40, flows from the heater-core side outlet 42 toward the heater core 13. The cooling water, flowing out of the heater core 13, flows from the heater-core side inlet 43 into the switching valve 40. The cooling water, flowing from the heater-core side inlet 43 into the switching valve 40, flows from the F/C side outlet 44 toward the fuel cell system 6. The switching valve 40 includes a valve body 45 that is movable in an up-down direction in FIGS. 2A, 2B, and the valve body 45 has first and second valve bodies 45a, 45b at its both ends. Further, the switching valve 40 includes a first valve seat 46 on which the first valve body 45a water-tightly contacts, and a second valve seat 47 on which the second valve body 45b water-tightly contacts. As shown in FIG. 2A, when no electric current is supplied to the valve body 45, the valve body 45 is placed at the uppermost position in its movable area. In this case, the first valve body 45a water-tightly contacts the first valve seat 46, and the second valve body 45b is separated from the second valve seat 47. As shown in FIG. 2B, when electric current is supplied to the valve body 45, the valve body 45 is placed at the lowermost position in its movable area. In this case, the first valve body 45a is separated from the first valve seat 46, and the second valve body 45b water-tightly contacts the second valve seat 47.

The switching valve 40 has therein a first water passage 50, a second water passage 51 and a third water passage 52. Cooling water, flowing from the heater-core side inlet 43 into the switching valve 40, flows to the heater-core side outlet 42 through the first water passage 50. The cooling water, flowing from the F/C side inlet 41 into the switching valve 40, flows to the heater-core side outlet 42 through the second water passage 51. The cooling water, flowing from the heater-core side inlet 43 into the switching valve 40, flows to the F/C side outlet 44 through the third water passage 52. The first and second water passages 50, 51 are opened and closed by the first and second valve bodies 45a, 45b, respectively, and the third water passage 52 is always opened.

When cooling water circulates in the second cooling-water passage 35 shown in FIG. 1A so as to pass through the fuel cell system 6 and the heater core 13, the valve body 45 is moved to the uppermost position in its movable area as shown in FIG. 2A. On the other hand, when cooling water circulates in the second cooling-water passage 35 so as to pass through the heater core 13 while bypassing the fuel cell system 6, the valve body 45 is moved to the lower most position in its movable area as shown in FIG. 2B. The switching valve 40 includes a control device 48 having a solenoid. The valve body 45 is controlled by the control device 48, and is moved by using electromagnetic force of the solenoid in the up-down direction as shown in FIGS. 2A, 2B. In this control, the valve body 45 is placed at the uppermost position in its movable area when no electrical current is applied to the switching valve 40, and the valve body 45 is placed at the lowermost position when electrical current is applied to the switching valve 40.

Accordingly, a first circuit of the present invention is constructed with the second cooling-water passage 35 including the second and third water passages 51, 52 of the switching valve 40. Further, a second circuit of the present invention is constructed with a water passage 35a of the second cooling-water passage 35 and the first water passage 50 of the switching valve 40. Specifically, the water passage 35a is provided at a side of the heater core 13 (in the right side in FIG. 1A) with respect to the switching valve 40.

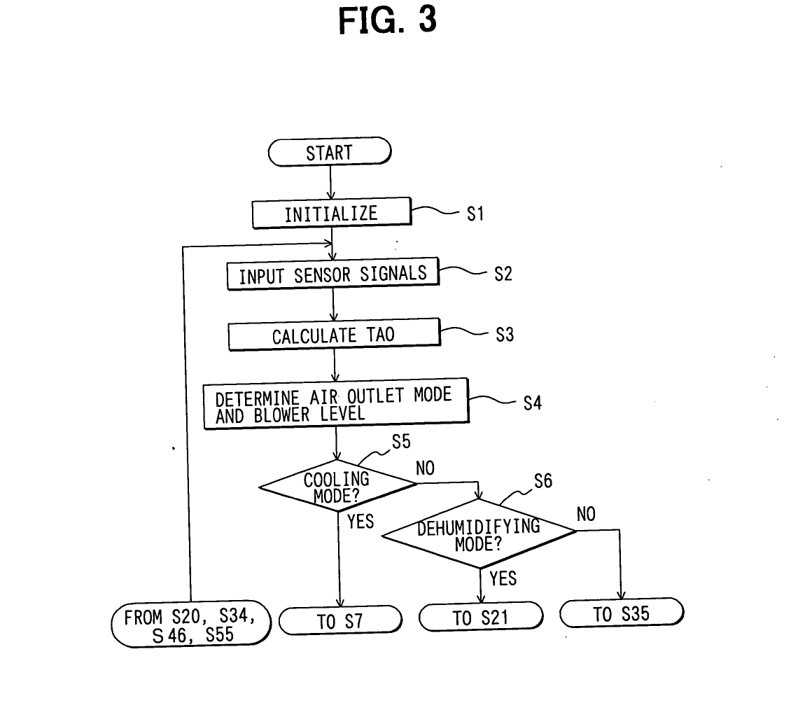

Next, control operation of the vehicle air conditioner according to the present embodiment will be described with reference to FIGS. 3-11. When the vehicle air conditioner is in an ON state, the A/C control unit 7 performs initialization of various data and the likes at step S1 in FIG. 3. Next, at step S2, the A/C control unit 7 reads various signals from the inside air temperature sensor 1,the outside air temperature sensor 2, the sunlight sensor 4, the temperature setting device 10, the temperature sensors 16, 65, 174 and the like, as shown in FIG. 3. Then, at step S3, a target blowing temperature TAO of air to be blown into the passenger compartment is calculated based on the input signals of step S2.

Specifically, the target blowing temperature TAO is calculated by using the following formula (1).

TAO=Kset×Tset−Kr×Tr−Kam×Tam−Ks×Ts+C (1)

wherein, Tr is an inside air temperature detected by the inside air temperature sensor 1, Tam is an outside air temperature detected by the outside air temperature sensor 2, Ts is a solar radiation amount detected by the sunlight sensor 4, Tset is a set temperature set by the temperature setting device 4, Kset, Kr, Kam and Ks are gain values, and C is a correction constant.

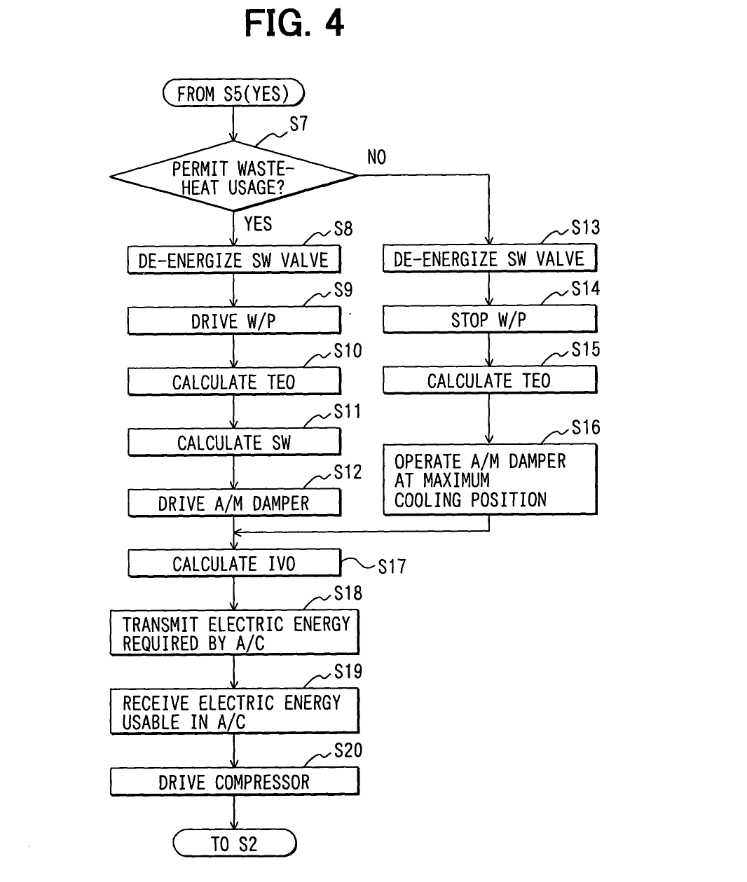

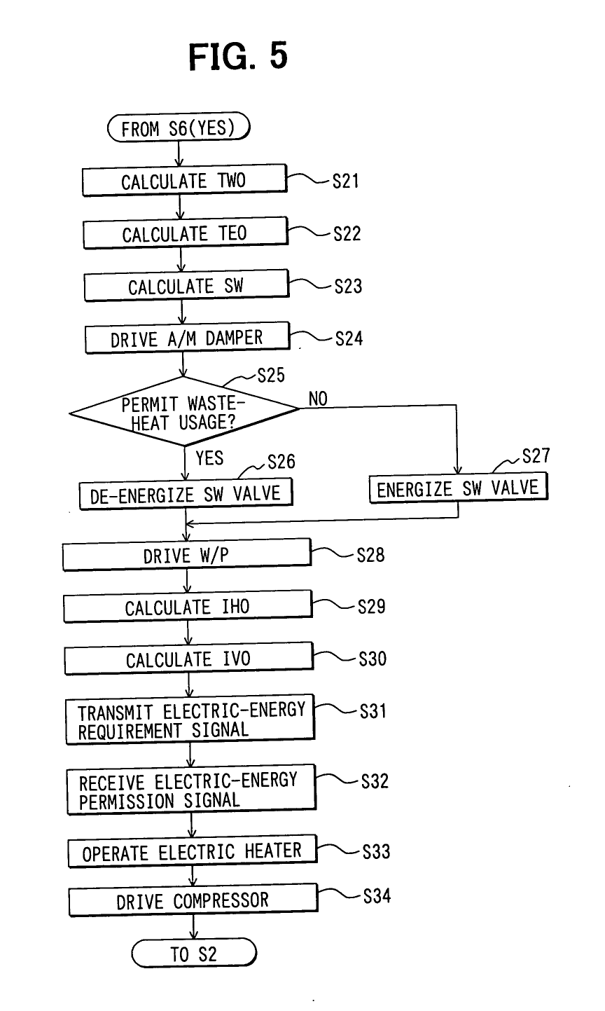

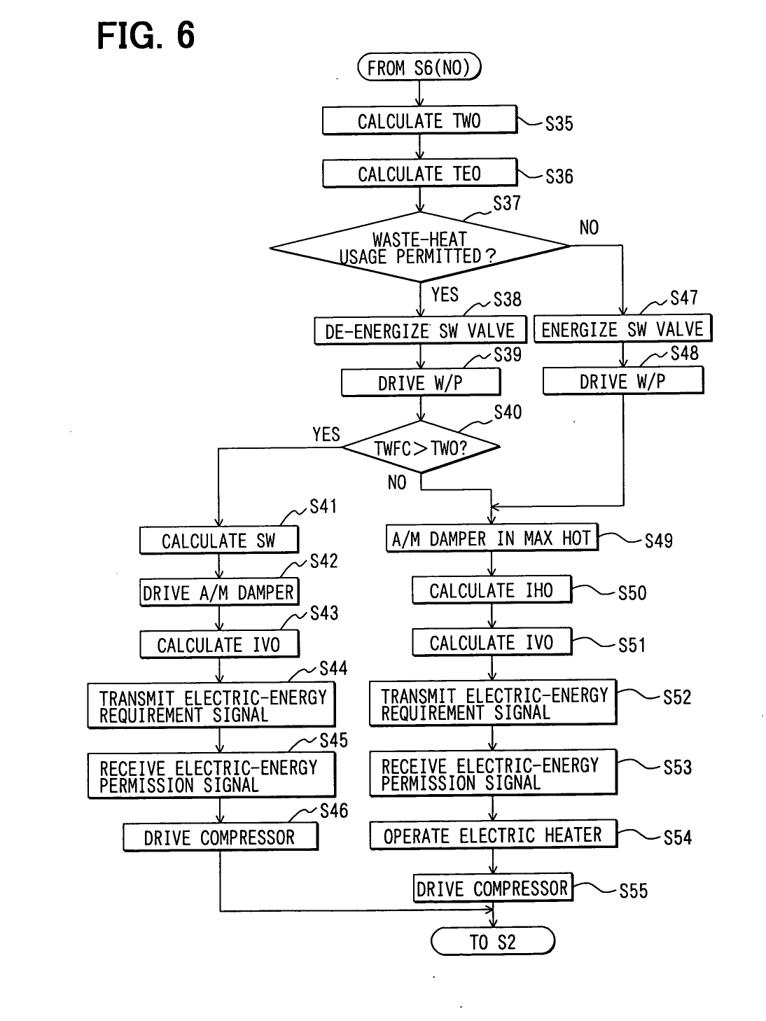

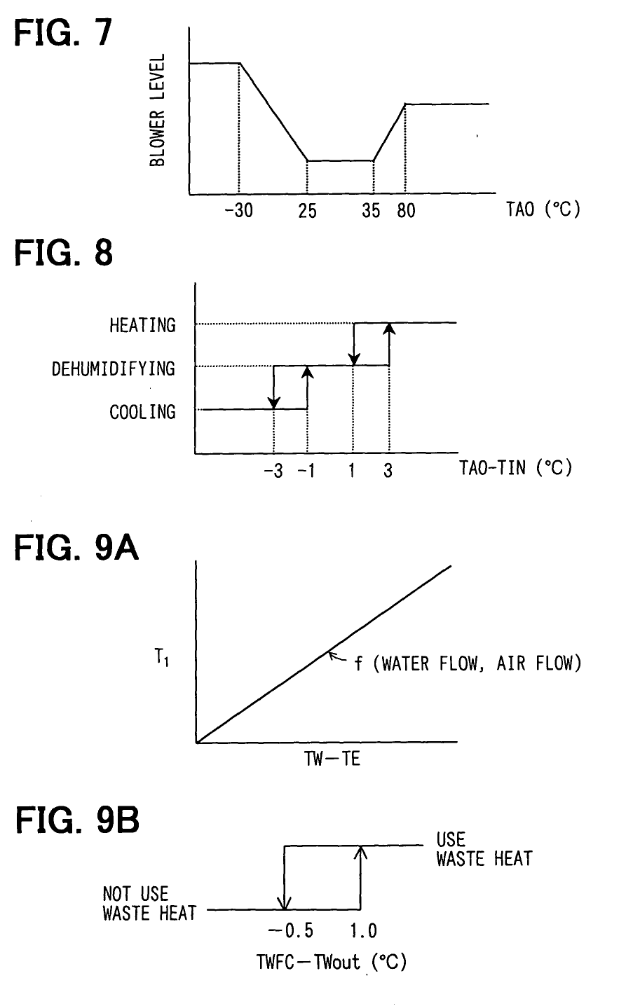

At step S4, a blower level, that is, an amount of air blown by the blower (not shown) is determined based on the calculated TAO as shown in FIG. 7, and an air outlet mode is determined based on the calculated TAO. At steps S5, S6, as shown in FIG. 8, an operation mode is determined based on the calculated TAO and a temperature TIN of air sucked into the air duct 20 of the air conditioner. Specifically, at step S5, it is determined whether or not the operation mode is a cooling mode, by using the relationship shown in FIG. 8, based on a difference between the target blowing temperature TAO and the air suction temperature TIN. When it is determined at step S5 that the operation mode is the cooling mode, the control program proceeds to step S7 shown in FIG. 4. When it is determined at step S5 that the cooling mode is not set, it is determined at step S6 by using the relationship shown in FIG. 8 whether or not the operation mode is a dehumidifying mode. When it is determined at step S6 that the dehumidifying mode is set, the control program proceeds to step S21 shown in FIG. 5. When it is determined at step S6 that the dehumidifying mode is not set, it is determined that a heating mode is set, and the control program proceeds to step S35 shown in FIG. 6.

When it is determined at step S5 that the cooling mode is set, the control program proceeds to step S7. At step S7 in FIG. 4, it is determined whether the unnecessary waste heat of the fuel cell system 6 is permitted to be used. Specifically, the A/C control unit 7 outputs a waste-heat requirement signal to the vehicle control unit 8, and receives a waste-heat permission signal from the vehicle control unit 8. When the waste-heat usage is permitted, that is, when the waste heat from the fuel cell system 6 is in a usable state, it is determined whether or not a cooling water temperature TWFC detected by the temperature sensor 174 is higher than a cooling water temperature TWout flowing from the heater core 13. When the cooling water temperature TWFC detected by the temperature sensor 174 is higher than the cooling water temperature Twout flowing from the heater core 13, it is determined that the waste heat of the fuel cell system 6 is in the usable state.

In the present embodiment, since a temperature sensor for detecting the cooling water temperature TWout flowing from the heater core 13 is not provided, the A/C control unit 7 estimates the cooling water temperature TWout based on other detection values. The temperature TWout can be estimated based on a cooling water temperature TW flowing into the heater core 13, detected by the temperature sensor 65, and heat radiation capacity in the heater core 13. In the present embodiment, the cooling water temperature TWout is estimated based on the cooling water temperature TW detected by the water temperature sensor 65, an air temperature TE (i.e., air temperature to flow into the heater core 13) blown from the evaporator 12, a cooling water flow amount passing through the heater core 13 and an air flow amount passing through the heater core 13. As shown in FIG. 9A, when the cooling water flow amount and the air flow amount passing through the heater core 13 are constant, a relationship between a temperature difference (TW−TE) and a reducing temperature T1 of cooling water while passing through the heater core 13 is linear as shown in FIG. 9A. This relationship has been found by the present inventors. When the cooling water flow amount and the air flow amount change, a gradient of this linear relationship is changed. Therefore, the cooling water temperature TWout flowing out of the heater core 13 can be readily estimated, based on the cooling water temperature TW flowing into the heater core 13, the air temperature TE from the evaporator 12, the cooling water amount passing through the heater core 13 and the air amount passing through the heater core 13.

By using the cooling water temperature TWout estimated in this way, it is determined whether or not the cooling water temperature TWFC detected by the water temperature sensor 174 is higher than the cooling water temperature TWout. Specifically, as shown in FIG. 9B, hysteresis is provided in a change direction of the temperature difference of (TWFC−TWout), and the waste heat using state is switched in accordance with the temperature difference of (TWFC−TWout). At step S7, when the waste heat usage is permitted by the vehicle control unit 8, and when it is determined that the cooling water temperature TWFC of the fuel cell system 6 is higher than the cooling water temperature Twout flowing out of the heater core 13, it is determined that the waste heat of the fuel cell system 6 can be used. Then, no electrical current is applied to the switching valve (SW valve) 40 at step S8, and the water pump (W/P) 61 is driven at step S9.

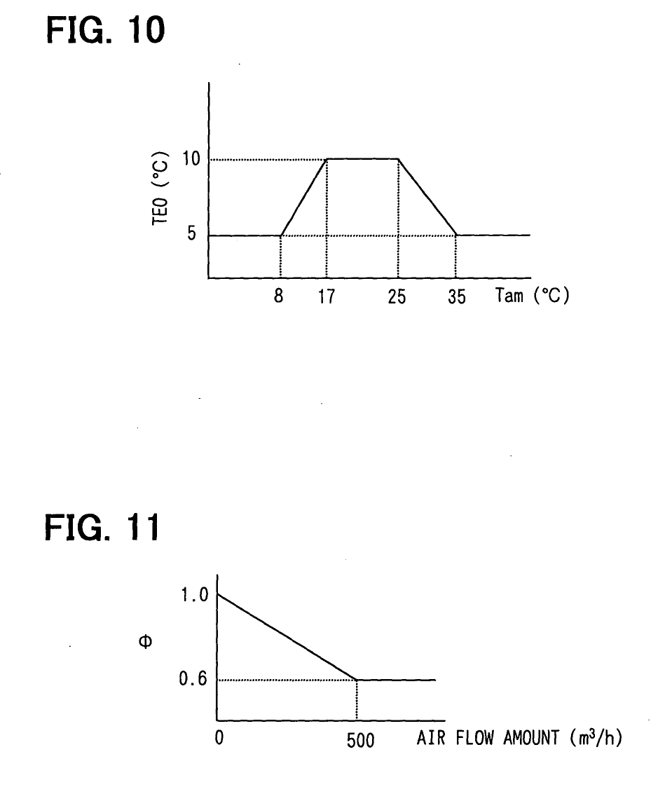

Then, at step S10, a target air temperature TEO blown out of the evaporator 12 is calculated. Specifically, as shown in FIG. 10, the target air temperature TEO blown out of the evaporator 12 is calculated in accordance with the outside air temperature Tam to perform dehumidification and the like. At step S11, a target opening degree SW of the air mixing damper 21 is calculated. Specifically, the target opening degree SW is calculated by using the following formula (2).

SW=(TAO−TE)/(TW−TE)×100% (2)

Wherein, TE is the detected temperature of air flowing from the evaporator 12, TW is the detected temperature of water flowing into the heater core 13, and TAO is the target blowing temperature of air to be blown into the passenger compartment.

At step S12, the air mixing damper (A/M damper) 21 is driven so that its opening degree is set at the calculated target opening degree SW.

When it is determined at step S7 that the waste heat usage is not permitted by the vehicle control unit 8, or when it is determined that the cooling water temperature TWFC is equal to or lower than the cooling water temperature TWout, that is, when it is determined that the waste heat of the fuel cell system 6 cannot be used, no electrical current is applied to the switching valve 40 at step S13, and the operation of the water pump 61 is stopped at step S14. Then, at step S15, the target air temperature TEO blown out of the evaporator 12 is calculated, and the target blowing temperature TAO is set at the target air temperature TEO. At step S16, the air mixing damper (A/M damper) 21 is operated to its maximum cooling position.

After step S12 is performed, or after step S16 is performed based on the target air temperature TEO calculated at step S10, a target rotational speed IVO of the electric compressor 15 is calculated at step S17. Then, at step S18, the A/C control unit 7 transmits an electric-energy requirement signal, indicating electric energy required by the air conditioner, to the vehicle control unit 8. At step S19, the A/C control unit 7 receives an electric-energy permission signal, indicating electric energy usable in the air conditioner, from the vehicle control unit 8. At step S20, the electric compressor 15 is driven by the A/C control unit 7 through the A/C inverter 9 so that the rotational speed of the electric compressor 15 approaches the target rotational speed IVO, calculated at step S17. Then, the control program returns to step S2 shown in FIG. 3.

When it is determined at step S6 that the dehumidifying mode is set, the control program proceeds to step S21 shown in FIG. 5, where a target water temperature TWO (e.g., 50° C. at step S21) of cooling water to flow into the heater core 13 is calculated. Then, the target air temperature TEO blown from the evaporator 12 is calculated at step S22, and the target opening degree SW of the air mixing damper 21 is calculated by using the formula (2) at step S23. At step S24, the air mixing damper 21 is driven so that its opening degree approaches the target opening degree SW. Then, at step S25, it is determined whether the waste heat usage is permitted by the vehicle control unit 8 as in step S7. When it is determined at step S25 that the waste heat usage is permitted, no electric current is applied to the switching valve 40 at step S26. On the other hand, when it is determined at step S25 that the waste heat usage is not permitted, electrical current is applied to the switching valve 40 at step S27.

After one of steps S26, S27 is performed, the water pump 61 is driven at step S28. Then, at step S29, a target heater power IHO to be supplied to the electric heater 60 is calculated based on the target water temperature TWO calculated at step S21 and the cooling water temperature TWFC detected by the temperature sensor 174. At step S30, the target rotational speed IVO of the electric compressor 15 is calculated based on the target air temperature TEO calculated at step S22. Then, the A/C control unit 7 transmits the electric-energy requirement signal to the vehicle control unit 8 at step S31, and receives the electric-energy permission signal from the vehicle control unit 8, at step S32.

At step S33, electric power is supplied to the electric heater 60 through the A/C inverter 9 so that the target heater power IHO calculated at step S29 is supplied to the electric heater 60 in the permitted electric energy. Further, at step S34, the electric compressor 15 is driven so that its rotational speed becomes the target rotational speed IVO calculated at step S30 in the permitted electric energy. When both target values IHO, IVO cannot be satisfied in the permitted electric energy, the electric compressor 15 is driven in preference to the electric heater 60, and electric current supplied to the electric heater 60 is adjusted based on the consumed electric power in the compressor 15 and the permitted electric energy. That is, the control at steps S33, S34 is performed so that a dehumidifying operation is considered in preference to an air temperature controlling operation. Thereafter, the control program returns to step S2 shown in FIG. 3.

When it is determined at step S6 that the dehumidifying mode is not set, that is, that the heating mode is set, the control program proceeds to step S35 shown in FIG. 6. The target water temperature TWO is calculated at step S35, and the target air temperature TEO blown from the evaporator 12 is calculated at step S36. Specifically, at step S35, the target water temperature TWO is calculated by using the following formula (3) based on a control value Φ that is set in accordance with an air flow amount from the air outlet, as shown in FIG. 11.

TWO=(TAO−TE)/Φ+TE (3)

At step S36, the target air temperature TEO is set at 10° C. when the outside air temperature Tam is higher than 10° C., and the target air temperature TEO is set at a higher temperature among the outside air temperature Tam and 5° C., when the outside air temperature Tam is equal to or lower than 10° C. Then, as in step S7, it is determined at step S37 whether the waste heat usage is permitted by the vehicle control unit 8. When it is determined at step S37 that the waste heat usage is permitted by the vehicle control unit 8, no electric current is carried to the switching valve 40 at step S38, and the water pump 61 is driven at step S39. Then, it is determined at step S40 whether the cooling water temperature TWFC detected by the temperature sensor 174 is higher than the target water temperature TWO calculated at step S35 or not. When it is determined at step S40 that the cooling water temperature TWFC is higher than the target water temperature TWO, the target opening degree SW of the air mixing damper 21 is calculated by using the formula (2) at step S41. At step S42, the air mixing damper is driven so that its opening degree becomes the target opening degree SW. At step S43, the target rotational speed IVO of the electric compressor 15 is calculated based on the target air temperature TEO calculated at step S36.

Then, the A/C control unit 7 transmits the electric-energy requirement signal to the vehicle control unit 8 at step S44, and receives the electric-energy permission signal from the vehicle control unit 8 at step S45. At step S46, the electric compressor 15 is driven through the A/C inverter 9 so that its rotational speed approaches the target rotational speed IVO calculated at step S43 in the permitted electric energy. Thereafter, the control step returns to step S2 shown in FIG. 3. When it is determined at step S37 that the waste heat usage is not permitted by the vehicle control unit 8, electrical current is applied to the switching valve at step S47, and the water pump 61 is driven at step S48. Alternatively, when it is determined at step S40 that the cooling water temperature TWFC is equal to or lower than the target water temperature TWO, the air mixing damper 21 is operated so that its opening degree is in a maximum heating state (maxhot) at step S49.

Then, at step S50, the target heater power IHO is calculated based on the target water temperature TWO calculated at step S35 and the cooling water temperature TWFC detected by the temperature sensor 174. At step S51, the target rotational speed IVO is calculated based on the target air temperature TEO calculated at step S36. Then, the A/C control unit 7 transmits the electric-energy requirement signal to the vehicle control unit 8 at step S52, and receives the electric-energy permission signal from the vehicle control unit 8 at step S53. At step S54, electric current is applied to the electric heater 60 through the A/C inverter 9 so that the target heater power IHO is applied thereto in the permitted electric energy. Then, at step S55, the electric compressor 15 is driven so that its rotational speed becomes the target rotational speed IVO in the permitted electric energy. When both of the target values IHO, IVO cannot be satisfied in the permitted electric energy, the electric compressor 15 is driven in preference to the electric heater 60, and the electric current carried to the electric heater 60 is adjusted. Thereafter, the control program returns to step S2 shown in FIG. 3.

In this embodiment, in a case where the blown air is required to be heated by the heater core 13, when the waste heat of the fuel cell system 6 is in the usable state and when the cooling water temperature TWFC detected by the temperature sensor 174 is higher than the cooling water temperature TWout from the heater core 13, no electric current is applied to the switching valve 40, thereby forming the cooling water circuit where cooling water is circulated from the heater core 13 into the fuel cell system 6. That is, when the cooling water temperature Twout from the heater core 13 is lower than the cooling water temperature TWFC from the fuel cell system 6, cooling water circulates between the heater core 13 and the fuel cell system 6. Accordingly, cooling water from the heater core 13 can be heated by the fuel cell system 6 having a temperature higher than the cooling water from the heater core 13, and is circulated to the heater core 13. In this way, the heater core 13 effectively uses thermal energy which is unnecessary in the fuel cell system 6.

In the present embodiment, the electric heater 60 as the auxiliary heater is provided upstream of the heater core 13 in the second cooling-water passage 35 in a water flow direction. Therefore, even when unnecessary thermal energy from the fuel cell system 6 is small, the electric heater 60 can heat cooling water before flowing into the heater core 13. In the present embodiment, because the electric heater 60 is provided upstream of the heater core 13 in the second cooling-water passage 35, a cooling water temperature flowing into the fuel cell system 6 can be readily reduced as compared with a case where the electric heater 60 is provided downstream of the heater core 13. Therefore, the thermal energy, which is unnecessary in the fuel cell system 6, can be further effectively used. Further, even when the switching valve 40 forms a closed circuit (corresponding to the second circuit in the present invention) where cooling water is not circulated to the fuel cell system 6, the electric heater 60 can heat cooling water before flowing into the heater core 13. In the present embodiment, the cooling water temperature TWout flowing out of the heater core 13 is calculated based on the cooling water temperature flowing into the heater core 13, the cooling water amount passing through the heater core 13, the air temperature TE flowing into the heater core 13 and the air flow amount passing through the heater core 13. Therefore, a temperature sensor, for directly detecting the cooling water temperature Twout flowing out of the heater core 13, is not required to be provided.

Although the present invention has been fully described in connection with the preferred embodiment thereof with reference to the accompanying drawings, it is to be noted that various changes and modifications will become apparent to those skilled in the art.

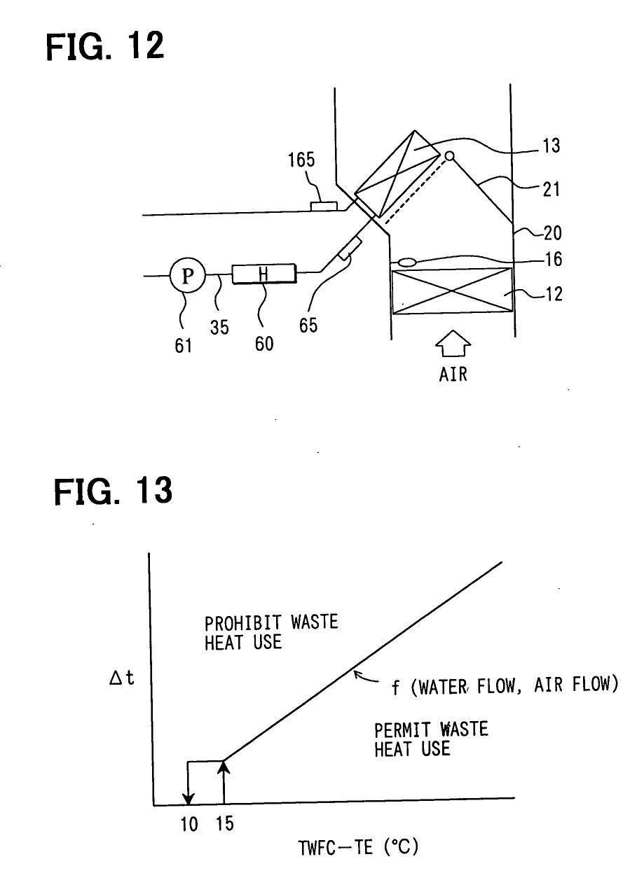

For example, in the above-described embodiment, the cooling water temperature TWout flowing from the heater core 13 is calculated and estimated. For example, a temperature sensor 165, for directly detecting the cooling water temperature TWout, may be provided downstream of the heater core 13 in the second cooling-water passage 35 as shown in FIG. 12. In this case, the cooling water temperature TWout can be more accurately detected.

In the above-described embodiment, the A/C control unit 7 calculates and estimates the cooling water temperature TWout based on the cooling water temperature TW to flow into the heater core 13, the cooling water flow amount passing through the heater core 13, the air temperature TE flowing from the evaporator 12 into the heater core 13, and the air flow amount passing through the heater core 13. Then, the switching control of the switching valve 40 is performed by using the calculated TWout. However, the switching control is not limited to this manner. For example, as shown by a slant line in FIG. 13, a limit value of a rising temperature Δt of the cooling water heated by the electric heater 60, in which the TWFC becomes the TWout, is obtained based on the cooling water temperature TWFC, the air temperature TE, the cooling water flow amount and the like. The switching control of the switching valve 40 can be performed based on the limit value (limit line). Specifically, when the rising temperature Δt becomes a value lower than the limit line in FIG. 13 by 2° C., the switching valve 40 is switched to a state shown in FIG. 2A. When the rising temperature Δt becomes a value lower than the limit line in FIG. 13 by 1° C., the switching valve 40 is switched to a state shown in FIG. 2B. Preferably, this switching control is performed with a hysteresis.

In the above embodiment, the electric heater 60 as the auxiliary heater is provided in the second cooling-water passage 35. However,the electric heater 60 may be provided at a downstream air side of the heater core so as to directly heat the blown air. In the above embodiment, when it is determined that the waste heat of the fuel cell system 6 is in the using state (usable state), the water pump 61 is controlled to be driven at steps S9, S28, S39. However, when cooling water can be suitably circulated in the second cooling-water passage 35 by operation of the water pump 5 at the vehicle side, the water pump 61 may be not required to be driven.

Further, for example, a three-way valve, or two two-way valves may be adopted to switch the cooling water circuit between the first circuit and the second circuit, without being limited to the switching valve 40 in the above embodiment. Further, the energization control to the electric heater 60 may be performed by an electromagnetic relay and the like, without being limited to the A/C inverter 9 in the above embodiment. Further, plural electric heaters may be used as the electric heater 60 in the second cooling-water passage 35 without being limited to the single electric heater 60 in the above embodiment. In this way, a peak current carried to the plural electric heaters can be reduced. Further, a real value such as 72° C. and 80° C. in the above embodiment is shown as an example, but can be suitably set in accordance with characteristics of the fuel cell system 6 and the likes.

Such changes and modifications are to be understood as being within the scope of the present invention as defined by the appended claims.

What is claimed is:

1. An air conditioner for a vehicle having a temperature-controlled apparatus, the air conditioner comprising:
a heating heat exchanger for heating air to be blown into a passenger compartment of the vehicle by using cooling water for cooling the temperature-controlled apparatus as a heating source;
a first circuit through which the cooling water passes through the temperature-controlled apparatus and the heating heat exchanger;
a second circuit through which the cooling water passes through the heating heat exchanger while bypassing the temperature-controlled apparatus;
a switching device for switching a cooling water circuit between the first and second circuits; and
a control unit for controlling the switching device so as to select the first circuit when a cooling water temperature flowing out of the heating heat exchanger is lower than a cooling water temperature flowing out of the temperature-controlled apparatus.

2. The air conditioner according to claim 1, further comprising
an auxiliary heater for heating air to be blown into the passenger compartment by supplying thermal energy to the cooling water to be circulated into the heating heat exchanger.

3. The air conditioner according to claim 2, wherein the auxiliary heater is arranged in the first and second circuits to heat the cooling water to be circulated into the heating heat exchanger in the first and second circuits.

4. The air conditioner according to claim 1, wherein the control unit calculates the cooling water temperature flowing out of the heating heat exchanger, based on a cooling water temperature flowing into the heating heat exchanger and a heat radiation capacity in the heating heat exchanger.

5. The air conditioner according to claim 1, wherein the control unit calculates the cooling water temperature flowing out of the heating heat exchanger, based on a cooling water temperature flowing into the heating heat exchanger, a flow amount of the cooling water passing through the heating heat exchanger, an air temperature flowing into the heating heat exchanger and an air flow amount passing through the heating heat exchanger.

6. The air conditioner according to claim 1, further comprising a temperature sensor for detecting the cooling water temperature flowing out of the heating heat exchanger, wherein the control unit controls the switching device so as to select one of the first and second circuits based on the cooling water temperature detected by the temperature sensor.

7. The air conditioner according to claim 1, wherein the control unit controls the switching device so as to select the first circuit, in a case where air to be blown into the passenger compartment is required to be heated by the heating heat exchanger and waste heat from the temperature-controlled apparatus is permitted to be used.

8. The air conditioner according to claim 1, wherein the temperature-controlled apparatus is a fuel cell system of the vehicle.
